(19) United States
(12) Patent Application Publication
(10) Pub. No.: US 2017/0127322 A1
(43) Pub. Date: May 4, 2017

(54) Reliability During Data Transmission and Adaptation of Transmission Strategy Based On Application

(71) Applicant: Telefonaktiebolaget LM Ericsson (publ), Stockholm (SE)

(72) Inventors: Bengt Lindoff, Bjärred (SE); Joakim Persson, Lund (SE)

(21) Appl. No.: 15/403,249

(22) Filed: Jan. 11, 2017

Related U.S. Application Data
(62) Division of application No. 14/787,290, filed on Oct. 27, 2015.

(51) Int. Cl. H04W 36/02; H04W 36/14; H04W 72/12; H04W 76/02

(52) U.S. Cl. CPC H04W 36/026; H04W 76/026; H04W 36/14; H04W 72/1268; H04W 72/1273

(57) ABSTRACT

A receiving device includes a control circuit. The control circuit receives a first data stream having been transmitted through a first operator and a second data stream having been transmitted through a second operator. The first data stream and second data stream originate from an application, e.g., executed on a remote mobile device. The control circuit combines the first data stream and the second data stream into a received data stream to be used by a corresponding application.

This application is a divisional application of U.S. patent application Ser. No. 14/787290, filed Oct. 27, 2015, which is a national stage application of PCT/EP2014/074945, filed Nov. 18, 2014, the disclosures of all of which are herein incorporated by reference in their entirety.

### TECHNICAL FIELD

This application relates to a method, a server, a radio frequency communication device, and a computer-readable storage medium for increased reliability, and in particular to a method, a server, a radio frequency communication device and a computer-readable storage medium for increased reliability of transmissions in dual SIM devices.

### BACKGROUND

A mobile radio frequency communication device is by definition mobile and as such it will have to connect to different base stations as it is moved. As the Mobile RF communications device moves, it will switch from one cell to another, each cell served by a base station (possibly the same but at different frequencies) and a handover from one cell to the other is affected.

A hard handover is a handover where the connection is (temporarily) broken and often a reconnect is necessary for any application that was using the connection.

A soft handover is a seamless handover where the application is not affected. However, even if the application is not affected the physical layer and the radio frequency interface will be affected and need to reconnect to the new cell. This is most of the time done in such a short time that most applications do not suffer. In LTE for instance, once a handover (HO) have been triggered by the modem of the radio frequency interface (i.e. a neighboring cell has become sufficiently strong compared to the current serving cell, the device report that to the network (NW) node i.e. a “HO event”), and the NW node transmits a HO execute RRC message (meaning do HO to a target cell) to the modem, the device starts to sync to the target cell. Once the device is in-sync, the modem makes a random access and the connection to the new cell is initiated. Once a HO message complete message is transmitted from the modem to the NW node the UL/DL (Uplink/Downlink) data communication can start again. Hence, during this sync and initialization period, that may be between 10-1000 ms depending on HO type (IRAT takes longer than LTE intra frequency HO for instance), the modem is offline w.r.t. the NW node and no (application) data communication in UL and DL is possible.

High reliability and low latency (<20 ms) communication might be a hard to handle with current cellular communication systems (GSM/WCDMA/LTE) using simple (low power/low cost) modems in case the application utilizes mobility. As mentioned above, once a HO is initiated, an interrupt of 10-1000 ms in the UL/DL connection is made. For time critical applications such an interrupt may be problematic since the device needs to go into some fail safe mode at each HO. Furthermore, even if the reliability of HO in LTE is rather good, there is anyway a 1-2% risk for HO failure, and then a need for RRC re-establishment procedure to get the (IP) connection on again, giving even longer interrupts (seconds). Such a risk and such delays are far too high for critical applications such as for example remote surgery, which would enable complicated surgery to be done in remote or exposed areas. Other examples are various tactile applications, industrial automation, vehicular control and military applications.

Hence, there is a need for a method and a mobile RF communication device for increasing the reliability in high reliability, real time, low latency applications using cellular communications such as LTE.

### SUMMARY

The problem, that the inventors have realized after inventive and insightful reasoning and that the present invention aims to solve, arises because there is no redundancy in the connections.

The prior art proposes to utilize dual SIM devices to introduce a redundancy for applications where a low-level communication Radio Access Technology (RAT), such as GSM (Global System Mobile), serves as a backup for a high-level RAT, such as LTE (Long Term Evolution). However, such systems suffer in that the low-level RAT cannot handle the traffic generated by the High-level RAT.

The prior art also includes dual SIM devices aimed at different operators both serving the same level of RAT. Such systems are however designed to separate the traffic on the two SIM cards to differentiate between for example private and business traffic and are as such incompatible with any redundancy system as a redundancy system cannot be separated.

It is an object of the teachings of this application to overcome or at least mitigate the problems listed above by providing a mobile RF communication device comprising a radio frequency communications interface and a controller, said radio frequency communications interface comprising at least a first RF modem connected to a first SIM module configured for receiving a first SIM card associated with a first operator and a first RF modem connected to a second SIM module configured for receiving a second SIM card associated with a second operator, wherein said mobile RF communication device is configured for dual SIM operation and wherein said controller is configured to: execute an application; assemble a data stream to be transmitted from the application; duplicate the data stream into a first data stream and a second data stream; transmit the first data stream over the first RF modem through the first operator to a receiving device; and transmit the second data stream over the second RF modem through the first operator to the receiving device, whereby a redundant transmission of the data stream is achieved.

It is also an object of the teachings of this application to overcome or at least mitigate the problems listed above by providing a mobile RF communication device comprising a radio frequency communications interface and a controller, said radio frequency communications interface comprising at least a first RF modem connected to a first SIM module configured for receiving a first SIM card associated with a first operator and a first RF modem connected to a second SIM module configured for receiving a second SIM card associated with a second operator, wherein said mobile RF communication device is configured for dual SIM operation and wherein said controller is configured to: execute an application; determine a transmission priority for the application; and determine a transmission strategy based on the transmission priority, wherein the transmission strategy is at least one of the following: to use a single SIM-carrier aggregation connection, to use a single SIM-single carrier connection, and to use a dual SIM-single carrier connection; and, when the transmission strategy is to use a dual SIM-single carrier connection then: assemble a data stream to be transmitted from the application; duplicate the data stream into a first data stream and a second data stream; transmit the first data stream over the first RF modem through the first operator to a receiving device; and transmit the second data stream over the second RF modem through the first operator to the receiving device, whereby a redundant transmission of the data stream is achieved.

It is also an object of the teachings of this application to overcome or at least mitigate the problems listed above by providing a mobile RF communication device comprising a radio frequency communications interface and a controller, wherein said controller is configured to: execute an application; assemble a data stream to be transmitted from the application; duplicate the data stream into a first data stream and a second data stream; transmit the first data stream through a first address to a receiving device; and transmit the second data stream through a second address to the receiving device, whereby a redundant transmission of the data stream is achieved.

In one embodiment the mobile radio frequency communication device is a mobile communications terminal.

It is also an object of the teachings of this application to overcome or at least mitigate the problems listed above by providing a receiving device arranged for receiving a first data stream having been transmitted through a first operator and a second data stream having been transmitted through a second operator originating from an application, said receiving device comprising a controller configured to: receive at least one of the first data stream and the second data stream and combine the at least one of the first data stream and the second data stream into a received data stream to be used by a corresponding application.

In one embodiment the receiving device is a mobile communications terminal.

It is a further object of the teachings of this application to overcome the problems listed above by providing a method for use in a mobile RF communication device comprising a radio frequency communications interface and a controller, said radio frequency communications interface comprising at least a first RF modem connected to a first SIM module configured for receiving a first SIM card associated with a first operator and a first RF modem connected to a second SIM module configured for receiving a second SIM card associated with a second operator, wherein said mobile RF communication device is configured for dual SIM operation and wherein the method comprises: executing an application; assembling a data stream to be transmitted from the application; duplicating the data stream into a first data stream and a second data stream; transmitting the first data stream over the first RF modem through the first operator to a receiving device; and transmitting the second data stream over the second RF modem through the first operator to the receiving device, whereby a redundant transmission of the data stream is achieved.

It is a further object of the teachings of this application to overcome the problems listed above by providing a method for use in a mobile RF communication device comprising a radio frequency communications interface and a controller, said radio frequency communications interface comprising at least a first RF modem connected to a first SIM module configured for receiving a first SIM card associated with a first operator and a first RF modem connected to a second SIM module configured for receiving a second SIM card associated with a second operator, wherein said mobile RF communication device is configured for dual SIM operation and wherein the method comprises executing an application; determining a transmission priority for the application; and determining a transmission strategy based on the transmission priority, wherein the transmission strategy is at least one of the following: to use a single SIM-carrier aggregation connection, to use a single SIM-single carrier connection, and to use a dual SIM-single carrier connection; and, when the transmission strategy is to use a dual SIM-single carrier connection then: assembling a data stream to be transmitted from the application; duplicating the data stream into a first data stream and a second data stream; transmitting the first data stream over the first RF modem through the first operator to a receiving device; and transmitting the second data stream over the second RF modem through the first operator to the receiving device, whereby a redundant transmission of the data stream is achieved.

It is a further object of the teachings of this application to overcome the problems listed above by providing a method for use in a mobile RF communication device comprising a radio frequency communications interface and a controller, wherein the method comprises executing an application; assembling a data stream to be transmitted from the application; duplicating the data stream into a first data stream and a second data stream; transmitting the first data stream through a first address to a receiving device; and transmitting the second data stream through a second address to the receiving device, whereby a redundant transmission of the data stream is achieved.

It is a further object of the teachings of this application to overcome the problems listed above by providing a method for use in a receiving device arranged for receiving a first data stream having been transmitted through a first operator and a second data stream having been transmitted through a second operator originating from an application, said method comprising: receiving at least one of the first data stream and the second data stream and combining the at least one of the first data stream and the second data stream into a received data stream to be used by a corresponding application.

It is a further object of the teachings of this application to overcome the problems listed above by providing a computer readable medium comprising instructions that when loaded into and executed by a controller, such as a processor, cause the execution of a method according to herein.

The inventors of the present application have realized, after inventive and insightful reasoning that by utilizing the dual SIM functionality and going against the contemporary use of sending differentiated and separated data over the two channels, redundancy may be achieved for a more reliable transmission of time critical data.

Other features and advantages of the disclosed embodiments will appear from the attached detailed disclosure.

### BRIEF DESCRIPTION OF THE DRAWINGS

The invention will be described in further detail under reference to the accompanying drawings in which:

FIG. 1 shows a schematic view of a radio frequency communication device according to one embodiment of the teachings of this application;

FIG. 2 shows a schematic view of a network node according to one embodiment of the teachings of this application;

FIG. 3 shows a schematic view of a general dual SIM communication network according to one embodiment of the teachings of this application;

FIG. 4 shows a schematic view of a computer-readable medium according to one embodiment of the teachings of this application;

FIGS. 5A, 5B and 5C each show an instance of a schematic view of a RF communication network according to one embodiment of the teachings of this application;

FIG. 6A shows a schematic view of how the data stream is transmitted as two separate data streams according to one embodiment of the teachings of this application;

FIG. 6B shows a schematic view of how a data stream can be transmitted in two encoded data streams according to one embodiment of the teachings of this application;

FIG. 7 shows an example of a communication network according to one embodiment of the teachings of this application;

FIG. 8 shows a flowchart for a general method for a Mobile RF communications device arranged according to one embodiment of the teachings of this application;

FIG. 9 shows a flowchart for a corresponding general method for a receiving device arranged according to one embodiment of the teachings of this application;

FIG. 10 shows a flowchart of a general method for a Mobile RF communications device according to one embodiment of the teachings of this application;

FIG. 11 shows a flowchart for a general method according to herein for a Mobile RF communications device to transmit using single SIM-dual carrier capability according to one embodiment of the teachings of this application;

FIG. 12 shows a flowchart for a general method according to herein for a Mobile RF communications device to transmit using single SIM-single carrier capability according to an embodiment of the teachings of this application; and

FIG. 13 shows an example of a communication network according to one embodiment of the teachings of this application.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

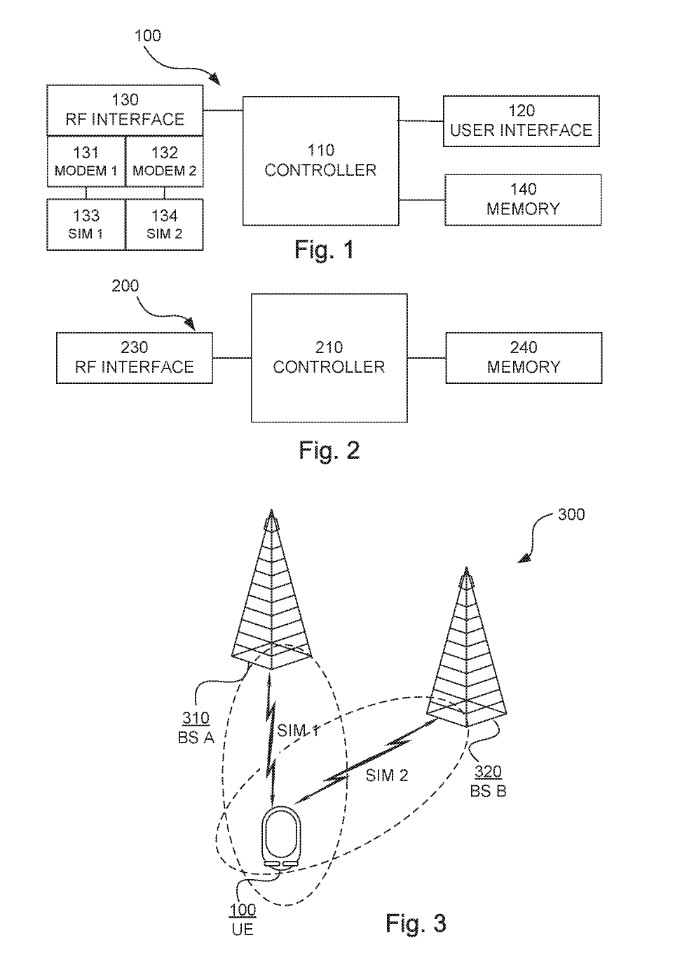

FIG. 1 shows a schematic example of a radio frequency (RF) communication device 100 according to one embodiment of the teachings herein. In this example, the mobile RF communication device 100 is a mobile communications terminal, such as a mobile phone, a wireless computer tablet or a laptop computer enabled for wireless communication, also commonly referred to as User Equipment (UE), but it should be noted that the teachings herein are not restricted to be used in mobile communications terminals, but may be used in any mobile RF communication device 100 that is arranged as will be disclosed herein. The mobile RF communication device 100 may comprise a user interface 120, which in the example embodiment of FIG. 1 may comprise at least one physical key, a visual data feedback unit, such as a display or Light Emitting Diode (LED) array. The mobile RF communication device 100 so comprises a controller 110 and a memory 140. The controller 110 may be implemented as one or several processors or other logic circuits, such as programmable logic circuits. The memory 140 may be implemented using any commonly known technology for computer-readable memories such as ROM, RAM, SRAM, DRAM, FLASH, DDR, EEPROM memory, flash memory, hard drive, optical storage or any combination thereof. The memory 140 is used for various purposes by the controller 110, such as for storing program instructions and application data.

The Mobile RF communications device 100 is arranged to execute a time critical application, which may be stored in the memory 140.

The mobile RF communication device 100 further comprises a radio frequency (RF) communication interface 130 which is configured to communicate according to one or a combination of the standards Universal Mobile Telecommunications System (UMTS), 3GPP Long Term Evolution (LTE), High Speed Packet Access, HSPA, or Global System for Mobile communication, GSM or any future fifth generation cellular communication standard. It should be noted that the teachings herein might also be implemented using other cellular communications standards.

The RF interface comprises two (or more) RF modems, a first RF modem and a second RF modem 131, 132. In one embodiment the first and the second RF modems 131, 132 may be logical modems being implemented as logical parts of the same physical RF transmitter.

Each RF modem 131, 132 is operably connected to a SIM (Subscriber Identity Module) module. The first RF modem 131 being connected to a first SIM module 133 and the second RF modem 132 being connected to a second SIM module 134. The SIM modules 133, 134 are configured to read and write data from and to a SIM card. The SIM modules 133, 134 may not have a direct connection with the RF modems 131, 132, but the connection may be over a common data bus (not shown explicitly) and/or the controller 110. Each SIM card is associated with a cellular service subscription and in one embodiment the first SIM card is associated with a first operator and the second SIM card is associated with a second operator. In one embodiment, the first SIM card is associated with a 2G, 3G or 4G subscription and the second SIM card is associated with a 2G, 3G or 4G subscription. The function of a SIM module is known to a skilled person and will not be disclosed in further details.

The mobile RF communication device 100 is thus arranged to operate with dual SIM cards. Dual SIM card operation may be effected as both cards being, or rather the subscriptions corresponding to the SIM cards, active at the same time (both capable of transmitting simultaneously, that is having active connections to respective network nodes or base stations simultaneously) or as both cards being in standby at the same time, but as one card is active in communication, the other card may not be active. This is commonly referred to as DSDA (Dual SIM Dual Active) The RF interface 130 may be employed in different manners including: single SIM-single carrier where one SIM module is used for communication over one carrier; single SIM-dual carrier, where one SIM module is used for communication over two carriers, possibly through a time division protocol; and dual SIM-dual carrier, where two SIM modules are communicating over each a carrier. Combinations are also possible, for example single SIM-dual carrier on both SIM modules.

The RF interface 130 may also be configured to communicate according to one or a combination of at least one of the standards IEEE 802.11 (W-Fi), Bluetooth®, NFC (Near Field Communication) or other short range (radio frequency) communication interface, RFID (Radio Frequency Identification) and ZigBee.

The controller 110 is operatively connected to the RF communication interface 130 for communicating with other mobile RF communication devices as will be disclosed below with reference to FIG. 3.

FIG. 2 shows a schematic example of a receiving device 200, such as an application server or application according to one embodiment of the teachings herein. The receiving device 200 may be a Mobile RF communications device as in FIG. 1, a mobile phone, a personal digital assistant, a computer tablet, a laptop computer, a desktop computer, a work station or other computing device arranged to execute an application being a counterpart of the time critical counterpart being executed by the Mobile RF communications device 100. The receiving device 200 may be implemented as software in a computing device in which case, the description with reference to FIG. 2 is for the computing device implementing the receiving device 200. The receiving device 200 may also be implemented as an application in a Mobile RF communications device 100 according to FIG. 1, in which case it will be clear that the common features of FIG. 1 and FIG. 2 are the same features.

The receiving device 200 comprises a controller 210 and a memory 240. The controller 210 may be implemented as one or several processors or other logic circuits, such as programmable logic circuits. The memory 240 may be implemented using any commonly known technology for computer-readable memories such as ROM, RAM, SRAM, DRAM, FLASH, DDR, EEPROM memory, flash memory, hard drive, optical storage or any combination thereof. The memory 240 is used for various purposes by the controller 210, such as for storing program instructions and application data.

The receiving device 200 may further comprise or be connected to a radio frequency (RF) communication interface 230 which is configured to communicate according to one or a combination of the standards Universal Mobile Telecommunications System (UMTS), 3GPP Long Term Evolution (LTE), High Speed Packet Access, HSPA, or Global System for Mobile communication, GSM. It should be noted that the teachings herein may also be implemented using other cellular communications standards. The receiving device 200 may be connected to the RF interface 230 remotely through a series of network connections, such as through the internet, see for example FIG. 7.

The controller 210 is operatively connected to the RF communication interface 230 for communicating with mobile RF communication devices as will be disclosed below with reference to FIG. 3.

FIG. 3 schematically shows a radio frequency communication network 300 according to the teachings herein. A first base station 310 is arranged to communicate with a mobile RF communication device 100 according to FIG. 1, such as a user equipment (UE). The base station 310 may be arranged to communicate according to a cellular communication standard, such as LTE (Long-Term evolution) or 3GPP (3G Partner Project), GSM (Global System Mobile) or other commonly known radio access technology (RAT), such as disclosed with reference to FIG. 2. The first base station 310 is arranged to communicate with the mobile RF communication device 100 according to the subscription of the first SIM card SIM 1 as indicated by the dashed arrow. In one embodiment the first SIM card is associated with a first operator A that operates the first base station 310 (as indicated by the abbreviation BS A in FIG. 3). As is indicated by the dashed oval emanating from the first base station 310, the mobile RF communication device 100 is within the coverage of the first base station 310 to which it is connected. In layman's terms, the mobile RF communication device 100 is connected to the cell of the first base station 310.

The communication network 300 further comprises a second base station 320, which is arranged to communicate with the mobile RF communication device 100 according to the subscription of the second SIM card SIM 2 as indicated by the dashed arrow. In one embodiment the second SIM card is associated with a second operator B which operates the second base station 320 (as indicated by the abbreviation BS B in FIG. 3). As is indicated by the dashed oval emanating from the second base station 320, the mobile RF communication device 100 is within the coverage of the second base station 320 to which it is connected. In layman's terms, the mobile RF communication device 100 is connected to the cell of the second base station 320.

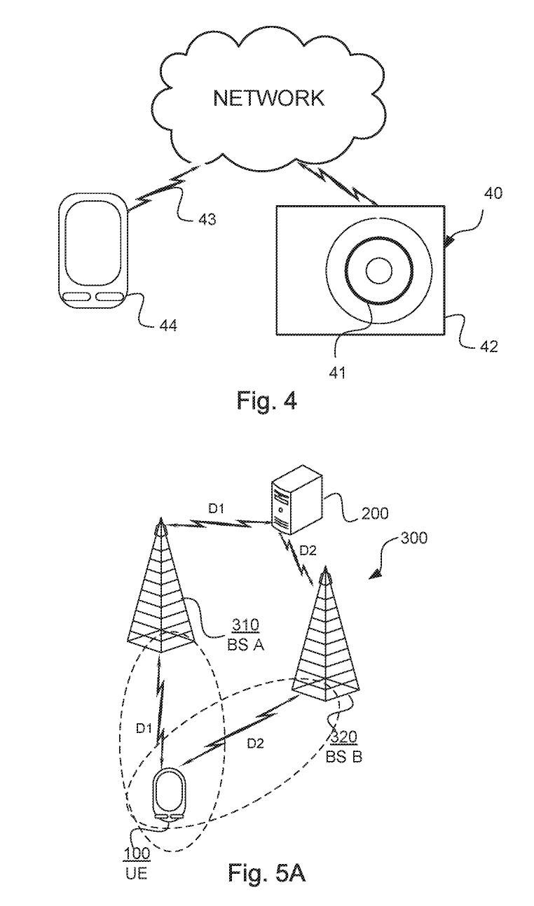

FIG. 4 shows a schematic view of a computer-readable medium as described in the above. The computer-readable medium 40 is in this embodiment a data disc 40. In one embodiment the data disc 40 is a magnetic data storage disc. The data disc 40 is configured to carry instructions 41 that when loaded into a controller, such as a processor, executes a method or procedure according to the embodiments disclosed above. The data disc 40 is arranged to be connected to or within and read by a reading device 42, for loading the instructions into the controller. One such example of a reading device 42 in combination with one (or several) data disc(s) 40 is a hard drive. It should be noted that the computer-readable medium could also be other mediums such as compact discs, digital video discs, flash memories or other memory technologies commonly used.

The instructions 41 may also be downloaded to a computer data reading device 44, such as a computer or other device capable of reading computer coded data on a computer-readable medium, by comprising the instructions 41 in a computer-readable signal 43 which is transmitted via a wireless (or wired) interface (for example via the Internet) to the computer data reading device 44 for loading the instructions 41 into a controller. In such an embodiment the computer-readable signal 43 is one type of a computer-readable medium 40.

The instructions may be stored in a memory (not shown explicitly in FIG. 4, but referenced 240 in FIG. 2) of the mobile RF communication device 100.

References to computer programs, instructions, code etc. should be understood to encompass software for a programmable processor or firmware such as, for example, the programmable content of a hardware device whether instructions for a processor, or configuration settings for a fixed-function device, gate array or programmable logic device etc.

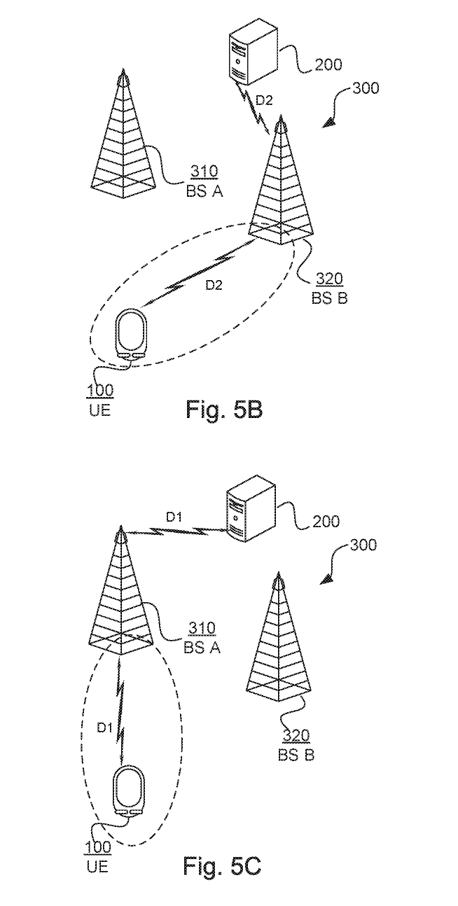

FIGS. 5A, 5B and 5C each show an instance of a schematic view of a RF communication network 300 according to the teachings herein.

A Mobile RF communications device, such as a UE 100 according to FIG. 1 is arranged to communicate (substantially) simultaneously through two operators by being connected to a first base station 310 and a second base station 320. The first base station 310 is associated with a first operator A and the second base station 320 is associated with a second operator B. The dual operator communication is substantially simultaneous in the case of single SIM-dual carrier communication.

To provide for redundancy for a time critical application, the Mobile RF communications device 100, or the application being executed by the controller 110 of the Mobile RF communications device 100, transmits two separate data streams D1 and D. The first data stream D1 is transmitted via the first operator A and the second data stream D2 is transmitted via the second operator B. In one embodiment, the first and second data streams are substantially the same in that they carry the same data, which is the data stream D for the time critical application. The data streams D1, D2 are transmitted or connected to an application device 200, which may be another Mobile RF communications device 100, a remote computer or other computing device capable of executing a counter part of the time critical application.

Let us now consider information that is transmitted from the UE to the application device 200. Starting with FIG. 5A, the Mobile RF communications device 100 is currently within coverage of both the first operator A and the second operator B as is indicated by the dashed ovals, and the Mobile RF communications device 100 transmits the two data streams D1 and D2 which are received by the receiving device 200. The server then combines the two data streams into a received data stream, which is used for the counterpart of the time critical application.

Should the Mobile RF communications device 100 lose a connection with one operator, such as during a handover, the server will still receive the data stream D in the form of either the first data stream D1 or the second data stream D2. FIG. 5B shows the example when the Mobile RF communications device 100 loses connection with the first operator A in which case the receiving device 200 receives the data stream D in the form of the second data stream D2 through the second operator B. FIG. 5C shows the example when the Mobile RF communications device 100 loses connection with the second operator B in which case the receiving device 200 receives the data stream D in the form of the first data stream D1 through the first operator A.

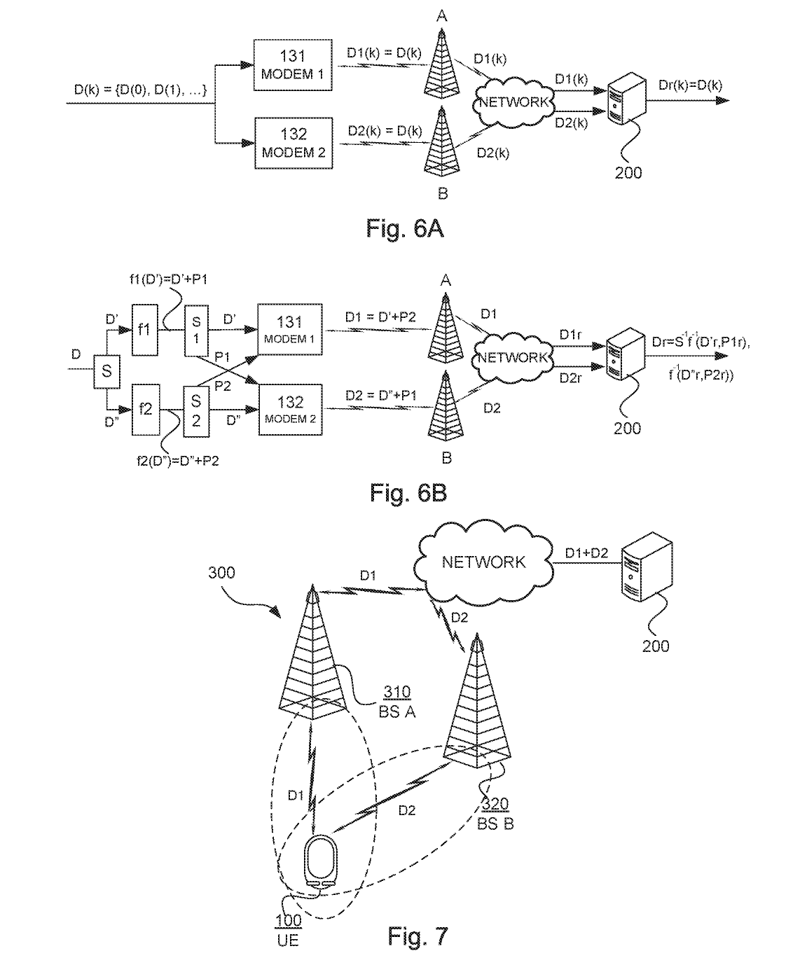

FIG. 6A shows a schematic view of how the data stream D(k)={D₀,D₁, D₂, . . . } is transmitted as two separate data streams D1(k) and D2(k), respectively, where D1(k)=D2(k)=D(k). The data stream D(k) is transmitted by the first RF modem 131 as the first data stream D1 through the first operator A. The data stream D(k) is also transmitted (substantially) simultaneously by the second RF modem 132 as the second data stream D2 through the second operator B. For notational convenience, we will sometimes write D, D1, and D2 when we refer to the data streams D(k), D1(k), and D2(k), respectively.

The receiving device 200 receives both the first data stream D1 and the second data stream D2 during operation when the Mobile RF communications device 100 is connected to both the first base station 310 and the second base station 320. The receiving device 200 then extracts data from either of the two received data streams in order to generate an estimate Dr(k), which ideally should correspond to the transmitted sequence D(k).

It does not matter whether D1 or D2 is used to obtain Dr as they convey the same information. In fact, in one embodiment, a combination of the first data stream D1 and the second data stream D2 may be used to obtain the received the received data stream Dr. The received data stream Dr may then be obtained by combining the data packages received in the first and second data stream which are received at a high(est) signal quality). Due to independent and stochastic networking delays for individual datagrams belonging to D1 and D2, there is no guarantee that corresponding parts of D1 and D2 arrive at the same time to the receiving application device 200, even if the streams are transmitted virtually at the same time. Moreover, if there is a handover (HO) outage on one of the SIM channels, the corresponding data stream may temporarily be severely delayed already at the transmitting UE compared to the data stream that is sent over the SIM channel without HO outage. This will cause a substantial difference in arrival time at the receiving device 200 for the affected parts of D1 and D2.

In order to handle differences in arrival time of the data streams, the transmitting and receiving end has to agree on a protocol that makes it possible for the receiving application device 200 to bookkeep what parts of the data streams D1 and D2 it has already used in the process of deriving Dr. One way to accomplish this is by dividing the data sequence into segments of appropriate size. The receiving device 200 marks a segment as used as soon as it has deducted the corresponding segment of Dr. Should it receive the same segment again at a later time on the other data stream, it can safely disregard this, as the corresponding data is already part of Dr.

As is normal when transmitting data, the data to be transmitted is often encoded. FIG. 6B shows a schematic view of how a data stream D can be transmitted in two encoded data streams D1 and D2. A splitter (S) placed before the encoder inputs divides the stream D into two separate streams, D′ and D″, respectively. This division can be made in different ways. One possibility is to have D′=D″=D. This ensures that every symbol of D is sent over both SIM channels and thereby increasing overall robustness. Another possibility is to partition D into two distinct subsets D′ and D″ and send these to encoders f1 and f2, respectively. One subset, e.g. D′, can be every even symbol from D (i.e., {D₀, D₂, . . . , D₂ₖ, . . . }) and the other subset, D″, can be every odd symbol from D (i.e., {D₁, D₃, . . . , D₂ₖ₊₁, . . . }). This scheme will increase overall data rate as every symbol of D is only sent over one SIM channel, but the robustness is worse than for the other case. It should be noted that the encoding functions f1 and f2 may be identical or different depending on what is most appropriate for a particular application as would be apparent to a skilled person. In the following description, no difference will be made between D′ and D″ and they will both be denoted D.

The data stream to be transmitted D is thus encoded and transmitted by each modem 131, 132 as two separate data streams D1 and D2. To allow for a higher redundancy and enabling the receiving device 200 to recreate a data stream should a portion of it be missing or received at low quality, the inventors have devised a clever manner of providing the increased redundancy by transmitting parity bits for encoding one data stream along with the other data stream. As can be seen in FIG. 6B, the data stream to be transmitted, D, is split (through S) into two sequences, D′ and D″, which are encoded by encoders f1 and f2, respectively. The first encoder f1 will provide a first encoded version of the data stream to be transmitted, D′ and parity bit(s) P1. The second encoder f2 will provide a second encoded version of the data stream to be transmitted, D″ and parity bit(s) P2. The first encoded version of the data stream to be transmitted, D′ and parity bit(s) P1, may be split in a splitter S1 and the second encoded version of the data stream to be transmitted, D″ and parity bit(s) P2, may be split in a splitter S2. This allows for the parity bits P1 and P2 to be combined with the other data stream and the resultant data streams D1 and D2 are transmitted by the corresponding modem. The first modem 131 thus transmits D′ and the parity bit(s) P2 obtained from the encoding of D″, and the second modem 132 thus transmits D″ and the parity bit(s) P1 obtained from the encoding of D′. Or, expressed as formulas:

D1=D′+P2, and

D2=D″+P1.

It should be noted that in another embodiment of the invention the parity bits may also be transmitted along with the corresponding encoded data stream, i.e. D1=f1(D′)=D′+P1 and D2=f2(D″)=D″+P2.

The device 200 receiving the two data streams D1r and D2r then generates an estimate, Dr, of the transmitted data stream, D, by reversing the encoding procedure. The device 200 extracts D′r, D″r, P1r, and P2r from the received sequences D1r and D2r. Then, combining D′r with P1r, and, D″r with P2r, each of these two sequences is decoded. Finally, Dr is generated from merging the decoded sequences using the reverse of the split function S. Denoting the two decoders by f1⁻¹ and f2⁻¹, respectively, and the merging function by S⁻¹, the decoding operation can be expressed as a formula:

Dr=S⁻¹(f1⁻¹(D′r, P1r), f2⁻¹(D″r,P2r)).

It should be noted that even though the focus of this description is to transmitting a data stream, the same teaching naturally applies to receiving a data stream. The Mobile RF communications device 100 is thus enabled to provide communication redundancy by communicating the same data stream D in two separate data streams D1, D2.

There exist an infinite number of schemes of varying complexity that can utilize the two available SIM channels by trading overall bit rate for robustness to handover (HO) outage. In general, the encoders f, f1 and f2 will add parity bits to the data that they encode. This will increase the length of the transmitted sequence compared to the length of the information sequence that enters the encoders, and, consequently, decrease the available user data rate. However, the parity bits can be used to recreate missing parts of either SIM channel that follows from an HO outage on that channel. In one embodiment of this invention, the parity bits of the encoder in f1 are transmitted over channel SIM2, while the parity bits of the encoder in f2 are transmitted over channel SIM1. When there is an HO outage over one of the two SIM channels, the receiver can use the parity bits received before, during and possibly after the outage at the other channel to recreate parts of or all of the lost information in the afflicted stream. By opting for different encoders (thereby changing the amount of parity data in the streams), it is possible to tune the overall communication link and trade user data rate for robustness to outage.

FIG. 7 shows an example of a communication network according to the teachings herein where the receiving device 200 is only communicating through one communication channel, such as by using one Internet Protocol address or International Mobile Subscriber identity. As can be seen, the receiving device 200 receives both the first data stream D1 and the second data stream D2 over the same channel.

The example embodiments of FIGS. 5A, 5B and 5C could be interpreted as the receiving device 200 also communicating over two separate communication channels such as through two Internet Protocol addresses or two International Mobile Subscriber identities.

In one embodiment the data stream to be transmitted is copied into the two data streams D1 and D2 on an application layer of a computer hierarchy, such as an OSI model, used by the Mobile RF communications device 100. The received data streams may also be combined at an application level of computer hierarchy used by the receiving device 200.

By implementing the copying and combining at an application level, it is easy to execute the application in a Mobile RF communications device 100 as no changes to the underlying system or layers are needed. The application arranged according to the teachings herein may simply be installed and executed. The application will also become less dependent on the current architecture being used by the Mobile RF communications device 100.

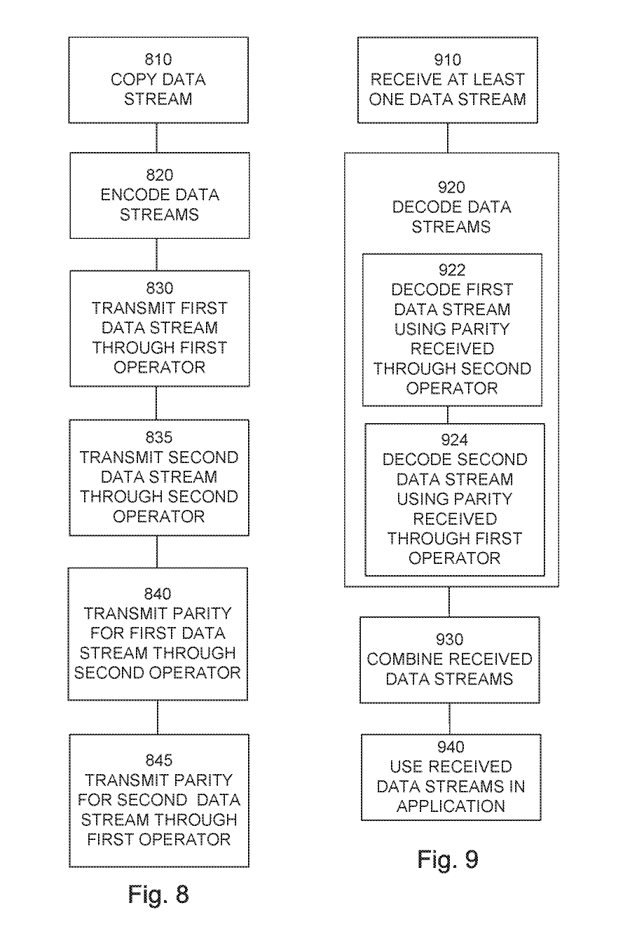

FIG. 8 shows a flowchart for a general method for a Mobile RF communications device 100 arranged according to the teachings herein. FIG. 9 shows a flowchart for a corresponding general method for a receiving device 200 arranged according to the teachings herein.

The Mobile RF communications device 100 assembles the data stream to be transmitted D from a time critical application and copies 810 it into a first and a second data stream D1 and D2 respectively. It should be noted that either of the first and second data streams may be the data stream to be transmitted, where D and D1 are transmitted or D and D2 are transmitted. The first data stream D1 is encoded 820 and transmitted 830 over the first modem 131 through the first operator A to the receiving device 200. The second data stream D2 is also encoded 820 and transmitted 835 over the second modem 132 through the second operator B to the receiving device 200 (substantially) simultaneously. The first data stream D1 may be transmitted along with a parity P2 for the second data stream D2 835 and the second data stream D2 may be transmitted along with a parity P1 for the first data stream D1. The parities may be transmitted as part of the data streams, concatenated to the data streams or using the same channel as the data streams.

The receiving device 200 receives the first data stream D1 and possibly also receives the second data stream D2, wherein the receiving device 200 has received 910 at least one data stream D1 and/or D2. At least one parity P1, P2 for the at least one data stream D1 and/or D2 is also received through the other operator as the corresponding data stream was received through, that is a parity for the first data stream is received through the second operator and a parity for the second data stream is received through the first operator. The at least one data stream D1 and/or D2 is then decoded 920. The at least one data stream D1 and/or D2 may be decoded using a parity that is received with the other of the at least one data stream D1 and/or D2, that is, the first data stream D1 may be decoded 922 using the parity P1 received through the second operator B and data stream D2 may be decoded 924 using the parity P2 received through the first operator A. The decoded data streams are then combined 930 into a received data stream Dr to be used 940 for a corresponding time critical application.

As would be understood, the teachings above trade a high reliability for a lower through put, which is necessary to incorporate the redundancy in the system.

In one embodiment the Mobile RF communications device 100 is thus configured to start duplicating the data stream to be transmitted only when it is detected that the signal quality of the used operator is deteriorating or when a hand over is to be effected. In this manner, the throughput can be maintained at a high level when the redundancy is not needed and the redundancy of using both modems is used when a high reliability is needed. The Mobile RF communications device 100 is thus configured to determine that a signal quality of a connection used is deteriorating or that a handover is to be effected and in response thereto start duplicating the data stream to be sent according to above.

Furthermore, to save power The Mobile RF communications device 100 is configured in one embodiment to use only one of the modems 131, 132 in a time-division manner to maintain connectivity towards the first operator A and monitor paging in the second operator network B. Here autonomous gaps would be created if needed in the active connection. The Mobile RF communications device 100 is thus configured to perform paging for the second operator B using the first modem 131, while transmitting data streams through the first operator (A) through the first modem (131).

According to the teachings herein, the Mobile RF communications device 100 may also be configured to duplicate the data stream to be transmitted and transmit the first and second data streams to different SIMs or other addresses at the receiving device 200, possibly through one modem. In this manner, the duplication can also be performed by a single SIM Mobile RF communications device or a Dual SIM Mobile RF communications device 100 operating in single SIM mode. In such an embodiment the receiving device is arranged with a radio interface having two RF modems, as the Mobile RF communications device 100 of FIG. 1.

This enables for a high reliability at a receiving device, such as a Mobile RF communications device 100.

However, not all applications are so time critical and the normal delay for a soft handover is sufficient and to allow for an increased robustness while still taking advantage of the available bandwidth, the inventors have devised a clever manner of adapting the transmission strategy of a Mobile RF communications device 100 based on the application to be executed.

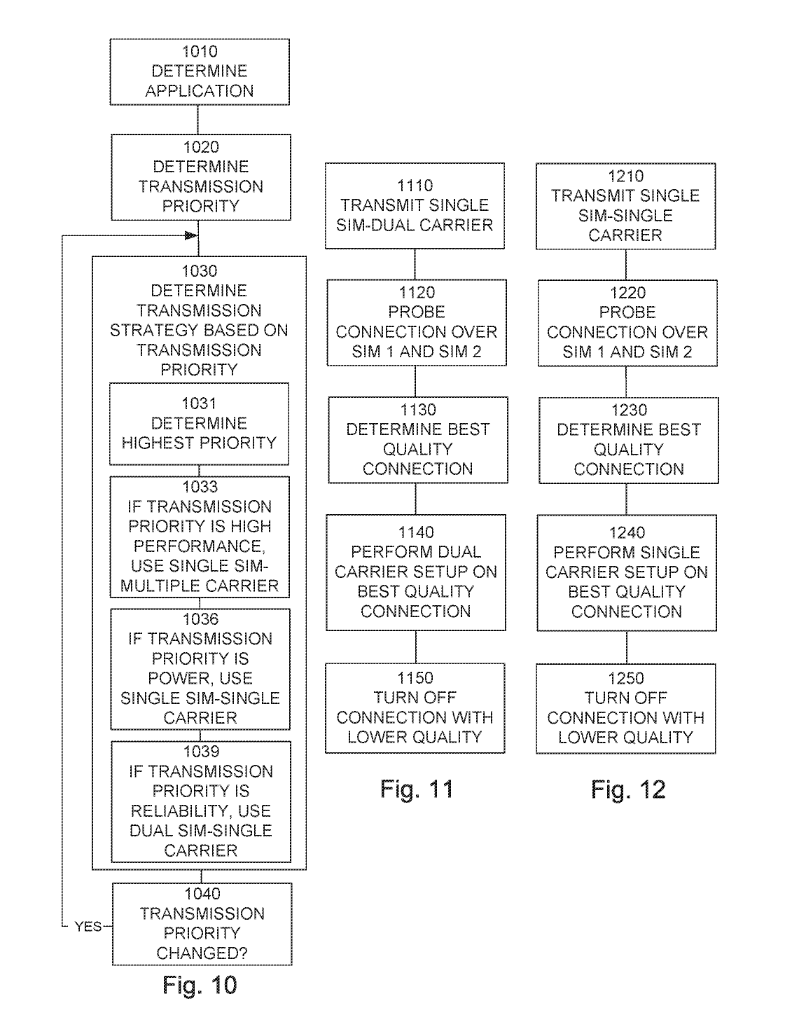

FIG. 10 shows a flowchart of a general method for a Mobile RF communications device 100 of the teachings herein. The Mobile RF communications device 100 determines 1010 which application is to be executed and determines 1020 the main transmission priority for the application. The transmission priority may relate to high performance, high throughput, best effort use case, low power consumption, high reliability or low latency to name a few priorities. The transmission priority may be retrieved from the application or it may be retrieved from a remote application server. The priority may also be received from the user after prompting by the user or through user settings.

The Mobile RF communications device 100 then determines 1030 the transmission strategy to be used based on the transmission priority.

If the transmission priority relates to high performance 1033, use or establish a single SIM-multiple carrier connection or carrier aggregation. If the transmission priority relates to low power consumption 1036, use or establish a single SIM-single carrier connection. If the transmission priority relates to high reliability 1039, use or establish a dual SIM-single carrier connection.

The Mobile RF communications device 100 then monitors the execution of the time critical application and determines if the transmission strategy needs to be changed 1040 and if so adapts the transmission strategy, possibly by determining a new transmission strategy 1030.

If the Mobile RF communications device 100 is executing more than one application concurrently, the Mobile RF communications device 100 may be configured to determine 1031 a highest priority of the applications and base the determination of the transmission strategy also on the application priority. For example if two applications are executing concurrently, one with a transmission priority of low power consumption and the other with a transmission priority of high performance, the Mobile RF communications device may use the transmission strategy to use single SIM-multiple carrier for the second application and single SIM-single carrier for the first application.

If two applications are executing concurrently, one with a transmission priority of high reliability and the other with a transmission priority of high performance, the Mobile RF communications device may use the transmission strategy to use single SIM-multiple carrier for the second application and dual SIM-single carrier for the first application, wherein one modem (and SIM) services both applications in a time division manner.

If the Mobile RF communications device 100 determines that a dual SIM transmission strategy is to be used, it may operate as has been explained in the above. If the Mobile RF communications device 100 determines that a single SIM transmission strategy is to be used, it may operate as will be disclosed below.

FIG. 11 shows a flowchart for a general method according to herein for a Mobile RF communications device 100 to transmit 1110 using single SIM-dual carrier capability. The Mobile RF communications device 100 probes for a connection 1120 over both the first modem 131 and the second modem 132, or for a connection with the first operator A through the subscription of the first SIM and for a connection with the second operator B through the subscription of the second SIM. The Mobile RF communications device 100 then determines which connection would give the best signal quality 1130 and performs a dual carrier connection setup 1140 on the connection giving the highest signal quality (which usually gives the lower power consumption) and reports dual carrier capability to the serving base station. The Mobile RF communications device 100 then turns off the modem not used 1150.

FIG. 12 shows a flowchart for a general method according to herein for a Mobile RF communications device 100 to transmit 1210 using single SIM-single carrier capability. The Mobile RF communications device 100 probes for a connection 1220 over both the first modem 131 and the second modem 132, or for a connection with the first operator A through the subscription of the first SIM and for a connection with the second operator B through the subscription of the second SIM. The Mobile RF communications device 100 then determines which connection would give the best signal quality 1230 and performs a single carrier connection setup 1240 on the connection giving the highest signal quality (which usually gives the lower power consumption). The Mobile RF communications device 100 then turns off the modem not used 1250.

The communication protocol according to herein also accommodates for differences in the cases when data is sent to a traditional receiver (who only uses one IP address) and when data is sent to a device that operates in DSDA mode (whereby two different IP addresses are being used—one for each SIM connection of the receiving end). Typically, an online server connected to the Internet, or, a traditional mobile device with only one SIM card, falls into the category of traditional receivers. Devices operating in DSDA mode send data to traditional receivers by using their single destination address for all traffic regardless if it is sent over physical port SIM1 (first modem 131) or SIM2 (second modem 132). If both peers operate in DSDA mode, traffic over SIM1 will use one of the receiving ends' IP addresses, and traffic over SIM2 will use the other IP address of the receiving end. Similarly, if the transmitter is a traditional device or a DSDA capable device that is not operated in DSDA mode (i.e., only uses one IP address) while the receiver is operated in DSDA mode, the outbound traffic will be duplicated and sent to each of the two addresses associated with the receiving end over the transmitter's single active network interface using time multiplexing. This improves reliability in the reception.

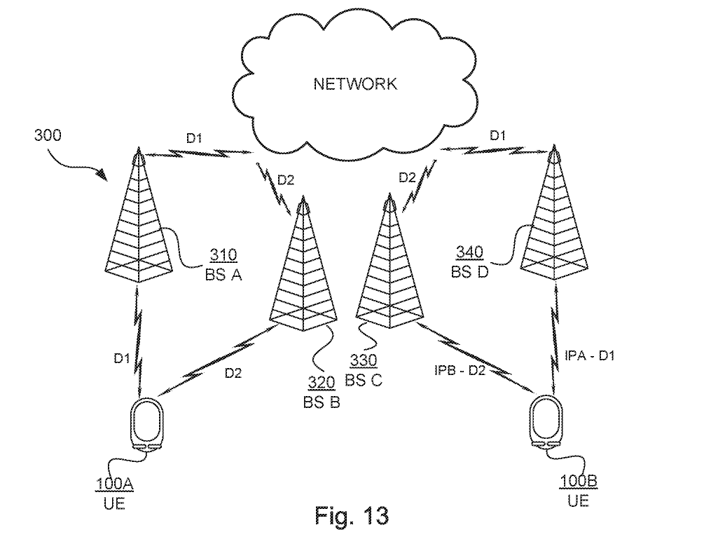

FIGS. 7 and 13 each illustrate a schematic view of one such implementation. In FIG. 7 a receiving device, such as a server 200, which could also be a mobile communications terminal 100, receives the first and second data streams D1 and D2 using one IP (or other) data address.

In FIG. 13 a receiving device, such as a mobile communications terminal 100B (or a server) is arranged to receive the first and second data streams over two different IP (or other) data addresses. A transmitting device, such as a mobile communications RF device 100 as in FIGS. 1 and 2 is arranged to send a first and second data stream D1 and D2 respectively through two operators, much as in FIG. 7. The receiving UE 100B is connected to the network, possibly via two base stations 330 and 340, possibly operating through different operators C and D, and is addressed with two different addresses IPA and IPB. The receiving device 100B is thus operating in a multiple carrier (or carrier aggregation) mode as well for the reception. It should be noted that one or both of the transmitting device 100A and the receiving device 100B may be arranged to operate both as a transmitting device 100A and a receiving device 100B thereby enabling a bidirectional multiple carrier or carrier aggregation data traffic.

By implementing the protocol for setting up and tearing down sessions involving one or two devices that are operated in DSDA mode at the same architectural level as where the processing of the data that is exchanged using this mode takes place, it is possible to build this solution without changing existing network protocols or modification to any 3GPP standard. It is also possible for a DSDA capable device to mix traffic in DSDA mode with traditional single SIM traffic based on settings and requirements for individual applications. However, doing this may affect the available data rate for DSDA mode traffic, as at least one of the SIM channels will now be shared for traffic belonging to two or more applications. As there are two SIM cards in the DSDA capable device, a new single SIM connection can be established over any of these. By monitoring traffic load and keeping track of pricing information for the different operators, it is possible to establish single SIM connections based on performance or cost criterion.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A receiving device comprising a control circuit, wherein the control circuit is configured to:
receive a first data stream having been transmitted through a first operator and a second data stream having been transmitted through a second operator, the first data stream and second data stream originating from an application;
combine the first data stream and the second data stream into a received data stream to be used by a corresponding application.

2. The receiving device of claim 1, wherein the control circuit is further configured to:
receive a parity for the first data stream, the parity having been transmitted through the second operator, and/or receive a parity for the second data stream, the parity having been transmitted through the first operator; and
decode the first data stream using the parity for the first data stream and/or decode the second data stream using the parity for the second data stream.

3. The receiving device of claim 1, wherein the control circuit is configured to combine the first data stream and the second data stream into the received data stream through a bitwise OR-operation on the received first data stream and second data stream.

4. The receiving device of claim 1, wherein the control circuit is configured to correct an interruption in one of the first data stream and second data stream using the other of the first data stream and second data stream by the combining of the first data stream and second data stream into the received data stream.

5. The receiving device of claim 4, wherein receiving the first and second data streams comprises receiving the first and second data streams from a remote mobile device and the interruption is induced by a handover of the remote mobile device.

6. The receiving device of claim 1, wherein the combining of the first data stream and the second data stream into a received data stream comprises selecting, based on signal quality, a data package for inclusion in the received data stream from corresponding data packages respectively received in the first and second data streams.

7. A method for use in a receiving device, the method comprising:
receiving a first data stream having been transmitted through a first operator and a second data stream having been transmitted through a second operator, the first data stream and second data stream originating from an application;
combining the first data stream and the second data stream into a received data stream to be used by a corresponding application.

8. The method of claim 7, further comprising:
receiving a parity for the first data stream, the parity having been transmitted through the second operator, and/or receiving a parity for the second data stream, the parity having been transmitted through the first operator; and
decoding the first data stream using the parity for the first data stream and/or decoding the second data stream using the parity for the second data stream.

9. The method of claim 7, wherein combining the first data stream and the second data stream into the received data stream comprises combining through a bitwise OR-operation on the received first data stream and second data stream.

10. The method of claim 7, further comprising correcting an interruption in one of the first data stream and second data stream using the other of the first data stream and second data stream by the combining of the first data stream and second data stream into the received data stream.

11. The method of claim 10, wherein the receiving of the first and second data streams comprises receiving the first and second data streams from a remote mobile device and the interruption is induced by a handover of the remote mobile device.

12. The method of claim 7, wherein the combining of the first data stream and the second data stream into a received data stream comprises selecting, based on signal quality, a data package for inclusion in the received data stream from corresponding data packages respectively received in the first and second data streams.

13. A non-transitory computer readable medium storing a computer program product for controlling a programmable network entity, the computer program product comprising software instructions that, when run on the programmable network entity, cause the programmable network entity to:
receive a first data stream having been transmitted through a first operator and a second data stream having been transmitted through a second operator, the first data stream and second data stream originating from an application;
combine the first data stream and the second data stream into a received data stream to be used by a corresponding application.

14. The non-transitory computer readable medium of claim 13, wherein the software instructions further cause the programmable network entity to:
receive a parity for the first data stream, the parity having been transmitted through the second operator, and/or receive a parity for the second data stream, the parity having been transmitted through the first operator; and
decode the first data stream using the parity for the first data stream and/or decode the second data stream using the parity for the second data stream.

15. The non-transitory computer readable medium of claim 13, wherein the software instructions cause the programmable network entity to combine the first data stream and the second data stream into the received data stream through a bitwise OR-operation on the received first data stream and second data stream.

16. The non-transitory computer readable medium of claim 13, wherein the software instructions cause the programmable network entity to correct an interruption in one of the first data stream and second data stream using the other of the first data stream and second data stream by the combining of the first data stream and second data stream into the received data stream.

17. The non-transitory computer readable medium of claim 16, wherein the software instructions cause the programmable network entity to receive the first and second data streams from a remote mobile device and the interruption is induced by a handover of the remote mobile device.

18. The non-transitory computer readable medium of claim 13, wherein the software instructions cause the programmable network entity to combine the first data stream and the second data stream into the received data stream by selecting, based on signal quality, a data package for inclusion in the received data stream from corresponding data packages respectively received in the first and second data streams.
